(19) United States
(12) Patent Application Publication
(10) Pub. No.: US 2026/0030411 A1
(43) Pub. Date: Jan. 29, 2026

(54) METHOD FOR CALCULATING CUTTERHEAD LOAD DURING SHIELD CUTTING OF DIAPHRAGM WALL WITH STEEL I-BEAM

(71) Applicants: Zhejiang University, Hangzhou (CN); Hangzhou Metro Group Co., Ltd., Hangzhou (CN); China Railway First Group Urban Track Transport Engineering Co., Ltd., Wuxi (CN)

(72) Inventors: Xiaowei YE, Hangzhou (CN); Weihuan TANG, Hangzhou (CN); Jundong MU, Hangzhou (CN); Jianshe QIN, Hangzhou (CN); Zhilin SONG, Hangzhou (CN); Ping WANG, Hangzhou (CN); Yonghui WANG, Hangzhou (CN); Yanbo CHEN, Hangzhou (CN)

(21) Appl. No.: 19/344,343

(22) Filed: Sep. 29, 2025

(30) Foreign Application Priority Data
May 23, 2025 (CN) 202510669597.7

(51) Int. Cl. G06F 30/23; G06F 30/17; G06F 111/10; G06F 119/14

(52) U.S. Cl. CPC G06F 30/23; G06F 30/17; G06F 2111/10; G06F 2119/14

(57) ABSTRACT

A method for calculating a cutterhead load during shield cutting of a diaphragm wall with a steel I-beam is provided. Numerical model parameters and operating state parameters of numerical simulation models are determined. The numerical simulation models are constructed. A disc cutter cutting linear velocity and a time interval between two adjacent disc cutter cutting actions are changed, and an interaction process between disc cutters varying in position on a cutterhead and the steel I-beam joint is simulated. Force-time mapping relationships of the disc cutters are outputted. Each disc cutter is numbered. A disc cutter database is constructed. The disc cutters are partitioned. Time parameters of each disc cutter are defined. A validity of the time parameters at a preset moment is evaluated. Valid time parameters are calculated. Vertical forces and rolling torques of the disc cutters with the valid time parameters are summed to calculate the cutterhead load.

### CROSS-REFERENCE TO RELATED APPLICATIONS

This application claims the benefit of priority from Chinese Patent Application No. 202510669597.7, filed on May 23, 2025. The content of the aforementioned application, including any intervening amendments made thereto, is incorporated herein by reference in its entirety.

### TECHNICAL FIELD

This application relates to tunnel engineering, and more particularly to a method for calculating a cutterhead load during shield cutting of a diaphragm wall with a steel I-beam.

### BACKGROUND

In the construction of urban rail transit networks, the scenario where newly built tunnel sections underpass existing stations at close range to achieve efficient transfers has become a common construction practice. During this process, tunnel boring machines need to penetrate through non-reserved diaphragm walls on both sides of the station. The manual obstruction removal method has been gradually replaced by the direct cutting method using tunnel boring machines due to its high cost and prolonged construction period.

During the tunneling process of a tunnel boring machine, the shield cutterhead rotates around its axis. Throughout one full rotation of the cutterhead, the relative position between the axis of the disc cutter and the diaphragm wall cyclically alternates between being parallel to and being perpendicular to the depth direction of the diaphragm wall. The frontal resistance and resistance moment experienced by the shield cutterhead are critical indicators determining whether the shield can successfully pass through when directly cutting steel-reinforced concrete diaphragm walls. Currently, there are numerous methods for calculating and predicting the cutterhead load during direct shield cutting of steel-reinforced concrete diaphragm wall. However, for the specific working condition where the shield boring machine must directly cut through steel I-beam joints within the diaphragm wall, there is limited research on methods for calculating the cutterhead load during the process of cutting these steel I-beam joints.

In order to prevent the steel I-beam base plate from detaching from its constraints at both ends under the scraping action of the disc cutter, being pushed by the disc cutter and rotating with the cutterhead on the tunnel face, and to avoid excessively long cut I-beam plates that fail to enter the soil chamber, the cutterhead is generally designed with a conical shape. Current methods for calculating the cutterhead load during shield cutting of steel-reinforced concrete diaphragm walls commonly treat the shield cutterhead as a flat plane. There is a lack of calculation methods that consider the conical design of the cutterhead for determining the load during shield cutting of steel I-beam joints in diaphragm walls. This leads to frequent inaccuracies in calculating the interaction with steel I-beam joints during actual shield cutterhead cutting of steel-reinforced concrete diaphragm walls, thereby affecting the construction process.

### SUMMARY

In view of the above problems in the prior art, the disclosure provides a method for calculating a cutterhead load during shield cutting of a diaphragm wall with a steel I-beam, which adopts combination of numerical simulation with a theoretical model. This method solves two issues, that is, the inaccuracy in calculating the force on disc cutters using only theoretical methods when the shield tunneling machine cuts the steel I-beam joints of diaphragm walls, and the cumbersome modeling process, huge calculation load, and poor model reusability when studying the interaction between the cutterhead and steel I-beam joints using only numerical simulation methods.

When the calculation method of the present disclosure demonstrates the positional relationship between the disc cutters on the cutterhead and the diaphragm wall during one rotation cycle of the cutterhead, it takes the first perpendicularity between the disc cutter's rotating shaft and the depth direction of the diaphragm wall as the starting point. After that, the disc cutter will sequentially go through the first parallelism between the rotating shaft and the depth direction of the diaphragm wall, the second perpendicularity, the second parallelism, and the third perpendicularity. When the third perpendicularity between the rotating shaft and the depth direction of the diaphragm wall is reached, the disc cutter completes one rotation cycle. Since the length of the flange plate of the steel I-beam joint of the diaphragm wall is much smaller than the diameter of the cutterhead, this method only considers the following stages when the disc cutter is in contact with the steel I-beam joint of the diaphragm wall: the first perpendicularity between the disc cutter's rotating shaft and the depth direction of the diaphragm wall, the first parallelism, the second parallelism, and the completion of one rotation cycle of the disc cutter.

Technical solutions of the present disclosure are described as follows.

In a first aspect, this application provides a method for calculating a cutterhead load during shield cutting of a diaphragm wall with a steel I-beam, comprising:
(1) determining numerical model parameters and operating state parameters of a first numerical simulation model and a second numerical simulation model for disc cutter-steel I-beam joint interaction;
(2) constructing the first numerical simulation model corresponding to a first cutting condition and the second numerical simulation model corresponding to a second cutting condition based on a positional relationship during disc cutter cutting of a steel I-beam joint;
(3) changing a disc cutter cutting linear velocity and a time interval between two adjacent disc cutter cutting actions, and simulating an interaction process between a plurality of disc cutters varying in position on a cutterhead and the steel I-beam joint;
(4) outputting mapping relationships between time and vertical forces exerted on the plurality of disc cutters during the interaction process, and outputting mapping relationships between time and rolling forces exerted on the plurality of disc cutters during the interaction process;
(5) numbering each of the plurality of disc cutters, and constructing a disc cutter database;
(6) partitioning the plurality of disc cutters based on different partitioning principles of the first cutting condition and the second cutting condition;
(7) defining time parameters of each of the plurality of disc cutters;
(8) evaluating a validity of the time parameters at a preset moment, and calculating values of valid time parameters among the time parameters; and
(9) summing vertical forces of disc cutters with the valid time parameters, summing rolling torques of the disc cutters with the valid time parameters, and calculating the cutterhead load at the preset moment.

In some embodiments, step (1) comprises:
(11) simulating the interaction process by using an LS-DYNA finite element software for dynamic analysis as a numerical analysis software;
(12) determining the numerical model parameters, wherein the numerical model parameters comprise dimensions of the plurality of disc cutters, dimensions of the steel I-beam joint, dimensions of a concrete encasing the steel I-beam, material model and parameters of the plurality of disc cutters, material model and parameters of the steel I-beam, material model and parameters of the concrete, and connection node type between the concrete and the steel I-beam joint; and
(13) determining the operating state parameters, wherein the operating state parameters comprise rotational angular velocity ω₀ of the plurality of disc cutters, rotation speed co of the cutterhead, penetration depth n of the plurality of disc cutters and advancing speed V of the cutterhead; and the advancing speed V is calculated through equation (1):

$$V = ω \cdot n . \qquad ( 1 )$$

In some embodiments, in step (2), the first cutting condition is a condition where a disc cutter axis is parallel to a depth direction of the diaphragm wall; the second cutting condition is a condition where the disc cutter axis is perpendicular to the depth direction.

In some embodiments, step (3) comprises:
(31) partitioning the steel I-beam joint and a concrete part in the second numerical simulation model into 5 first partitions along a direction perpendicular to a shield advancing direction to simulate the disc cutter cutting linear velocity of disc cutters in the second numerical simulation model among the plurality of disc cutters; wherein a distance from a midpoint of each of the 5 first partitions to a rotation axis of the cutterhead is dₙ(n=1, 2, . . . , 5), and n represents a partition number of the 5 first partitions; and
calculating the disc cutter cutting linear velocity corresponding to each of the 5 first partitions through equation (2):

$${v}_{n} = ω \cdot {d}_{n} ( n = 1 , 2 , … , 5 ) , \qquad ( 2 )$$

wherein vₙ is the disc cutter cutting linear velocity in an n-th partition among the 5 partitions, and a unit of the rotation speed c is r/min;
partitioning disc cutters in the first numerical simulation model among the plurality of disc cutters into N second partitions along a radial direction of the cutterhead to simulate the disc cutter cutting linear velocity in the first numerical simulation model; wherein the cutterhead is a conical cutterhead, N is a total number of stages of the conical cutterhead, a distance from a midpoint of each of the N second partitions to the rotation axis is dₘ(m=1, 2, . . . , N), and m is a partition number of the N second partitions; and
calculating the disc cutter cutting linear velocity corresponding to each of the N second partitions through equation (3):

$${v}_{m} = ω \cdot {d}_{m} ( m = 1 , 2 , … , N ) ; \qquad ( 3 )$$

(32) for the first numerical simulation model and the second numerical simulation model, due to a fact that depending on a disc cutter layout of different cutterheads, a specific location of the steel I-beam joint is subjected to a plurality of cutting actions by the plurality of disc cutters during one rotation cycle of the cutterhead, calculating the time interval through equation (4):

$$Δ {t}_{j} = \frac{{θ}_{i}}{ω} ( i = m , n ) , \qquad ( 4 )$$

wherein Δtᵢ is the time interval in an i-th partition among the 5 first partitions and the N second partitions, and B; is an angle between a line connecting one of the adjacent two disc cutters at a distance d; from a rotation center of the cutterhead to the rotation center and a line connecting the other of the adjacent two disc cutters at the distance d; from the rotation center to the rotation center;
(33) performing numerical simulation calculation on the 5 first partitions and the N second partitions to obtain numerical simulation results, wherein a cutting linear velocity of a disc cutter in the i-th partition cutting the steel I-beam joint and the concrete is vᵢ(i=m,n), the time interval of the disc cutter in the i-th partition is Δtᵢ(i=m,n), and the numerical simulation calculation is performed a total of 5+N times.

In some embodiments, step (4) comprises:
based on the numerical simulation results, obtaining a mapping relationship between time and a vertical force of a disc cutter in an m-th partition Fₘ(t)(m=1, 2, . . . , N), a mapping relationship between time and a vertical force of a disc cutter in the n-th partition fₙ(t)(n=1, 2, . . . , 5), a mapping relationship between time and a rolling force of the disc cutter in the m-th partition Tₘ(t)(m=1, 2, . . . , N), and a mapping relationship between time and a rolling force of the disc cutter in the n-th partition tₙ (t)(n=1, 2, . . . , 5).

In some embodiments, in step (5), a numbering principle for the plurality of disc cutters comprises:
a disc cutter number consists of a two-element array (i, j) referring to an j-th disc cutter on an i-th stage of the cutterhead, and x_{i,j} represents a distance from the j-th disc cutter on the i-th stage to a rotation center of the cutterhead; the disc cutter number (i, j) and the distance x_{i,j} of each of the plurality of disc cutters are stored into the disc cutter database with the disc cutter number serving as indexes of the plurality of disc cutters.

In some embodiments, the cutterhead is a conical cutterhead; and step (6) comprises:
(61) for the second numerical simulation model, partitioning the plurality of disc cutters into 5 first partitions along a radial direction of the cutterhead;
wherein disc cutters within a range of L<x_{i,j}≤L+(c+d)·sin α among the plurality of disc cutters only participate in cutting a soil-facing flange plate of the steel I-beam joint;
disc cutters within a range of

$$L + ( c + d ) \cdot sin α < {x}_{i , j} \leq L + d \cdot sin α + \frac{α}{cos α}$$

among the plurality of disc cutters participate in cutting the soil-facing flange plate and a soil-backing flange plate of the steel I-beam joint;
disc cutters within a range of

$$L + d \cdot sin α + \frac{a}{cos α} < {x}_{i , j} \leq L + d \cdot sin α + \frac{a}{cos α} + c \cdot sin α$$

among the plurality of disc cutters participate in cutting the soil-facing flange plate, the soil-backing flange plate, and a web plate of the steel I-beam joint;
disc cutters within a range of

$$L + d \cdot sin α + \frac{a}{cos α} + c \cdot sin α < {x}_{i , j} \leq L + ( a + b ) \cdot cos α + d \cdot sin α$$

among the plurality of disc cutters participate in cutting the soil-facing flange plate and the soil-backing flange plate;
disc cutters within a range of L+(a+b)·cos α+d·sin α<x_{i,j}≤L+(a+b)·cos α+d·sin α+(c+d)·sin α among the plurality of disc cutters only participate in cutting the soil-backing flange plate;
wherein L is a minimum distance from the soil-facing flange plate to the rotation center, a is an angle between the cutterhead and the steel I-beam joint; a is a length of a portion of the flange plate located on a first side of the web plate; b is a length of a portion of the right flange plate located on a second side of the web plate; c is a height of the web plate; d is a thickness of the flange plate and the web plate;
(62) for the first numerical simulation model, partitioning the plurality of disc cutters into N second partitions along the radial direction with stages of the conical cutterhead as boundaries, wherein N is a number of the stages; and
(63) after the partitioning is completed, storing partition information and the mapping relationships between time and the vertical forces and the mapping relationships between time and the rolling forces in the disc cutter database in one-to-one correspondence with the indexes.

In some embodiments, in step (7), the time parameters comprise T_{i,j(1)} and T_{i,j(2)} that are configured to describe a time difference when the plurality of disc cutters start contacting the steel I-beam; T_{i,j(1)} comprises T_{i,j(11)} and T_{i,j(12)} representing a first time parameter and a second time parameter of the j-th disc cutter on the i-th stage in the first cutting condition, respectively; T_{i,j(2)} represents a third time parameter of the j-th disc cutter on the i-th stage in second cutting condition; and the first time parameter T_{i,j(11)} the second time parameter T_{i,j(12)} and the third time parameter T_{i,j(2)} are solved through steps of
for the second cutting condition, it is set that iₘᵢₙ=I is a minimum value of i satisfying x_{i,j}>L, jₘᵢₙ=J is a minimum value of j on an I-th stage satisfying x_{i,j}>L, a moment when an outermost disc cutter on the I-th stage starts contacting the steel I-beam joint is t=0, and the outermost disc cutter is defined as an M-th disc cutter on the I-th stage, and the third time parameter T_{i,j(2)} is solved through steps of
(71) calculating the third time parameter of the M-th disc cutter on the I-th stage through equation (5):

$${T}_{I , M ( 2 )} = t , \qquad ( 5 )$$

wherein t is a time elapsed since a moment when the M-th disc cutter on the I-th stage starts contacting the steel I-beam joint;
(72) calculating the third time parameter of an (M−1)-th disc cutter on the I-th stage through equation (6):

$${T}_{I , ( M - 1 ) ( 2 )} = t - {t}_{Δ} ; \qquad ( 6 )$$

calculating the third time parameter of a J-th disc cutter on the I-th stage through equation (7):

$${T}_{I , J ( 2 )} = t - ( M - J ) {t}_{Δ} , \qquad ( 7 )$$

wherein t_{Δ} is a time difference between moments when adjacent two disc cutters on the I-th stage start contacting the steel I-beam joint, and is calculated through equation (8):

$${t}_{Δ} = \frac{Δ \cdot tan α}{V} , \qquad ( 8 )$$

wherein Δ is a disc cutter spacing on the I-th stage; V is an advancing speed of the cutterhead; M is a total number of disc cutters on the I-th stage;
(73) calculating the third time parameter of an M_{I+1}-th disc cutter on an (I+1)-th stage through equation (9):

$${T}_{( I + 1 ) , {M}_{I + 1} ( 2 )} = t - \frac{{h}_{I}}{V} , \qquad ( 9 )$$

wherein the M_{I+1}-th disc cutter is an outermost disc cutter on the (I+1)-th stage, h_{I} is a height difference between the I-th stage and the (I+1)-th stage; calculating the third time parameter of a J-th disc cutter on the (I+1)-th stage through equation (10):

$${T}_{( I + 1 ) , J ( 2 )} = t - \frac{{h}_{I}}{V} - ( {M}_{I + 1} - J ) {t}_{Δ} , \qquad ( 10 )$$

wherein M_{I+1} is a total number of disc cutters on the (I+1)-th stage;
(74) calculating the third time parameter of a J-th disc cutter on an (I₁−1)-th stage through equation (11):

$${T}_{{I}_{1} - 1 , J ( 2 )} = t - \frac{{{\sum }^{( {I}_{1} - 2 )}}_{i = 1} {h}_{i}}{V} - ( {M}_{{I}_{1} - 1} - J ) {t}_{Δ} ( I \leq ( {I}_{1} - 1 ) < {I}_{1} ) ; \qquad ( 11 )$$

wherein M₁ is a total number of disc cutters on the (I₁−1)-th stage, iₘₐₓ=I₁ is a maximum value of i satisfying x_{i,j}≤L+(a+b)·cos α+d·sin α+(c+d)·sin α, and the third time parameter of each disc cutter on an (I₁+1)-th to an N-th stage satisfies T_{i,j(2)}=0;
(75) storing third time parameters of the plurality of disc cutters in the disc cutter database in one-to-one correspondence with the indexes;
for the first cutting condition, the first time parameter T_{i,j(11)} and the second time parameter T_{i,j(12)} are solved through steps of:
(76) calculating a time when the (I₁−1)-th stage starts contacting the steel I-beam joint through equation (12):

$${T}_{( {I}_{1} - 1 ) ( 2 )} = t - \frac{{\sum }_{i = 1}^{{I}_{1} - 2} {h}_{i}}{V} ; \qquad ( 12 )$$

calculating a time t₁ elapsed from a moment when the the (I₁−1)-th stage starts contacting the steel I-beam joint until the J-th disc cutter on the (I₁−1)-th stage cuts the steel I-beam joint for a first time through equation (13):

$${t}_{1} = \frac{{cos}^{- 1} \frac{L}{{X}_{( {I}_{1} - 1 ) , J}}}{ω} ; \qquad ( 13 )$$

calculating the first time parameter of the J-th disc cutter on the (I₁−1)-th stage through equation (14):

$${T}_{( {I}_{1} - 1 ) , J ( 11 )} = {T}_{( {I}_{1} - 1 ) ( 2 )} - {t}_{1} = t - \frac{{\sum }_{i = I}^{( {I}_{1} - 2 )} {h}_{i}}{V} - \frac{{cos}^{- 1} \frac{L}{{x}_{( {I}_{1} - 1 ) , J}}}{ω} ; \qquad ( 14 )$$

(77) calculating a time t₂ elapsed from a moment when the J-th disc cutter on the (I₁−1)-th stage cuts the steel I-beam joint for the first time until a moment when the J-th disc cutter on the (I₁−1)-th stage cuts the steel I-beam joint for a second time through equation (15):

$${t}_{2} = \frac{2 ( π - {cos}^{1} \frac{L}{{x}_{( {I}_{1} - 1 ) , J}} )}{ω} ; \qquad ( 15 )$$

calculating the second time parameter of the J-th disc cutter on the (I₁−1)-th stage through equation (16):

$${T}_{( {I}_{1} - 1 ) , J ( 12 )} = {T}_{( {I}_{1} - 1 ) ( 2 )} - {t}_{1} - {t}_{2} - t - \frac{{\sum }_{i = I}^{( {I}_{1} - 2 )} {h}_{i}}{V} - \frac{2 π - {cos}^{- 1} \frac{L}{{x}_{( {I}_{1} - 1 ) , J}}}{ω} ; \qquad ( 16 )$$

(78) calculating T_{i,j(11)} and T_{i,j(12)} of any disc cutter on a stage satisfying i>I₁ with the same calculation method as steps (76) and (77), wherein values of T_{i,j(11)} and T_{i,j(12)} of any disc cutter on the stage satisfying i>I₁ are non-zero; and
storing the time parameters of the plurality of disc cutters in the disc cutter database in one-to-one correspondence with the indexes.

In some embodiments, in step (8), time parameters satisfying T_{i,j}>0 are determined as the valid time parameters, and the disc cutters with the valid time parameters are determined to be in an operating state.

In some embodiments, the cutterhead load comprises a frontal resistance F and a resistance moment T; and
step (9) is performed through steps of:
(91) calculating a vertical force F_{i,j} and a rolling torque T_{i,j} of each disc cutter with T_{i,j(2)}, T_{i,j(11)} and T_{i,j(12)} all greater than 0 among the disc cutters with the valid time parameters through equations (17) and (18), respectively:

$${F}_{i , j} = {F}_{m} ( {T}_{i , j ( 11 )} ) + {F}_{m} ( {T}_{i , j ( 12 )} ) + {f}_{n} ( {T}_{i , j ( 2 )} ) ; \qquad ( 17 )$$

$${T}_{i , j} = [ {T}_{m} ( {T}_{i , j ( 11 )} ) + {T}_{m} ( {T}_{i , j ( 12 )} ) + {t}_{n} ( {T}_{i , j ( 2 )} ) ] \cdot {x}_{i , j} ; \qquad ( 18 )$$

in contrast, each disc cutter with T_{i,j} less than 0 among the disc cutters with the valid time parameters satisfies Fₘ(T_{i,j})=fₙ(T_{i,j})=Tₘ(T_{i,j})=tₙ(T_{i,j})=0;
(92) summing vertical forces F_{i,j} disc cutters with T_{i,j} greater than 0 to obtain the frontal resistance F acting on the cutterhead at the preset moment t through equation (19):

$$F = {\sum }_{{T}_{i , j} > 0} {F}_{i , j} ; \qquad ( 19 )$$

summing rolling torques T_{i,j} of the disc cutters with T_{i,j} greater than 0 to obtain the resistance moment T acting on the cutterhead at the preset moment t through equation (20):

$$T = {\sum }_{{T}_{i , j} > 0} {T}_{i , j} ; \qquad ( 20 )$$

In a second aspect, this application provides a non-transitory computer-readable storage medium, wherein a computer instruction is stored on the non-transitory computer-readable storage medium; and the computer instruction is configured to be executed by a processor to implement the above method.

In a third aspect, this application provides an electronic device, comprising:
a processor;
a memory; and
a computer program stored on the memory;
wherein the computer program is configured to be executed by the processor to implement the above method.

The most significant innovations of the present disclosure are as follows

1. A novel cutterhead load calculation method for shield tunneling machine cutting the steel I-beam joint of the diaphragm wall is proposed, which combines numerical simulation and theoretical model. Since the disc cutters are the main cutting tools of the cutterhead for cutting the steel-reinforced diaphragm wall, and the disc cutters have velocities in three directions (self-rotation, rotation with the cutterhead, and forward advancement), direct numerical simulation modeling is complex, involves a huge amount of calculation, and cannot be reused in different engineering projects. The idea of the calculation method proposed in the present disclosure is as follows. First, a variation law of the force on a single disc cutter with time during the cutting process (i.e., the force-time relationship of the disc cutter) is obtained through numerical simulation. Then, the operating state of the disc cutters during the forward advancement of the cutterhead is evaluated based on the proposed theoretical model. Finally, the forces of the disc cutters in the cutting state are summed to obtain the force applied on the cutterhead.

2. For special working conditions such as conical cutterheads and cutterheads forming a certain angle with the diaphragm wall, the disc cutters at different positions on the cutterhead start to contact the diaphragm wall at different times. This results in the fact that, at any given moment, each disc cutter on the cutterhead corresponds to a different value at a specific time point in the force-time relationship. In order to solve this problem, the present disclosure innovatively proposes the concept of a time parameter for the disc cutters on the cutterhead, which is configured to evaluate whether a disc cutter enters the cutting state by checking if the time parameter is positive. For disc cutters that enters the cutting state, the force exerted on the disc cutter at any moment can be obtained by substituting the time parameter into the force-time relationship.

Compared to the prior art, the present disclosure has the following beneficial effects. The method provided in the present disclosure improves the accuracy of force calculation when disc cutters cut the steel I-beam joint, and reveals the mapping relationship between vertical force, rolling force and time during the process of disc cutters cutting the steel I-beam joint. The constructed cutterhead load calculation model can calculate the load on the cutterhead at a specific moment when cutting the steel I-beam joint. By combining numerical simulation with the theoretical model, this method avoids the problems of cumbersome modeling process, huge calculation amount and poor model reusability that occur when fully using numerical simulation to analyze the interaction between the cutterhead and the steel I-beam joint.

### BRIEF DESCRIPTION OF THE DRAWINGS

FIG. 1 is a flow chart of a method for calculating a cutterhead load during shield cutting of a diaphragm wall with a steel I-beam in accordance with an embodiment of the present disclosure;

FIG. 2 is a two-dimensional (2D) schematic diagram of a first numerical simulation model for a first cutting condition in accordance with an embodiment of the present disclosure, where a disc cutter axis is parallel to a depth direction of the diaphragm wall;

FIG. 3 is a 2D schematic diagram of a second numerical simulation model for a second cutting condition in accordance with an embodiment of the present disclosure, where the disc cutter axis is perpendicular to the depth direction;

FIG. 4 is a 2D schematic diagram of a disc cutter distribution on a shield cutterhead in accordance with an embodiment of the present disclosure;

FIG. 5 is a schematic diagram of a numbering method for a conical cutterhead in accordance with an embodiment of the present disclosure;

FIG. 6 illustrates radial partitioning of disc cutters on the conical cutterhead in accordance with an embodiment of the present disclosure;

FIG. 7 illustrates moment when an I-th stage of the cutterhead contacts a steel I-beam joint in accordance with an embodiment of the present disclosure;

FIG. 8 illustrates moment when an N-th stage of the cutterhead contacts the steel I-beam joint in accordance with an embodiment of the present disclosure;

FIG. 9 is a schematic diagram of a disc cutter at an arbitrary position contacting the steel I-beam joint twice under the first cutting condition during one rotation cycle of the cutterhead in accordance with an embodiment of the present disclosure; and

FIG. 10 illustrates cross-sectional dimensions of the steel I-beam joint in Embodiment 1 of the present disclosure.

In the drawings: 21. disc cutter model of a first cutting condition; 22. concrete model of the first cutting condition; 23. steel I-beam joint model of the first cutting condition; 24. disc cutter movement direction of the first cutting condition; 31. first partition; 32. second partition; 33. third partition; 34. fourth partition; 35. fifth partition; 36. disc cutter model of the second cutting condition; 37. cutterhead advancing direction; 38. concrete model of the second cutting condition; 39. steel I-beam joint model of the second cutting condition; 41. rotation center; 42. distance from a specific disc cutter to the rotation center; 43. specific disc cutter; 44. adjacent disc cutter at the same distance from the rotation center as the specific disc cutter; 45. included angle between adjacent disc cutters; 51. first cutterhead stage; 52. second cutterhead stage; 53. third cutterhead stage; 54. N-th cutterhead stage; 55. first disc cutter on the first cutterhead stage; 56. second disc cutter on the first cutterhead stage; 57. M-th disc cutter on the third cutterhead stage; 58. J-th disc cutter on the N-th cutterhead stage; 61. closest distance from a soil-facing flange plate of the steel I-beam joint to the rotation center before contact; 62. sixth partition; 63. seventh partition; 64. eighth partition; 65. nineth partition; 66. tenth partition; 67. angle between the cutterhead and the steel I-beam joint before contact; 71. I-th cutterhead stage; 72. J-th disc cutter on the I-th cutterhead stage; 73. height difference between the I-th cutterhead stage and an (I+1)-th cutterhead stage; 74. disc cutter spacing on the I-th cutterhead stage; 75. angle between the cutterhead and the steel I-beam joint at the moment the I-th cutterhead stage starts contact; 76. (I+1)-th cutterhead stage; 77. M-th disc cutter on the (I+1)-th cutterhead stage; 78. J-th disc cutter on the (I+1)-th cutterhead stage; 79. M-th disc cutter on the I-th cutterhead stage; 81. (I₁−1)-th cutterhead stage viewed from a direction perpendicular to the cutterhead advancing direction; 82. J-th disc cutter on the (I₁−1)-th cutterhead stage; 83. (I₁−1)-th cutterhead stage; 84. J-th disc cutter on an I₁-th cutterhead stage; 85. angle between the cutterhead and the steel I-beam joint at the moment the J-th disc cutter on the (I₁−1)-th cutterhead stage starts contact; 86. all cutterheads from an (I₁+1)-th cutterhead stage to an N-th cutterhead stage; 91. (I₁−1)-th cutterhead stage viewed from a direction parallel to the cutterhead advancing direction; 92. closest distance from the soil-side flange plate of the steel I-beam joint to the rotation center viewed from a direction parallel to the cutterhead advancing direction; 93. first contact of the J-th disc cutter on the (I₁−1)-th cutterhead stage with the steel I-beam joint under the first cutting condition; 94. second contact of the J-th disc cutter on the (I₁−1)-th cutterhead stage with the steel I-beam joint under the first cutting condition; 95. cutterhead rotation direction; 101. length of the left flange plate of the steel I-beam joint web; 102. length of the right flange plate of the steel I-beam joint web; 103. height of the steel I-beam joint web; 104. thickness of the flange plate; and 105. thickness of the web plate.

### DETAILED DESCRIPTION OF EMBODIMENTS

The present disclosure will be further described below in conjunction with the accompanying drawings and embodiments.

### Embodiment 1

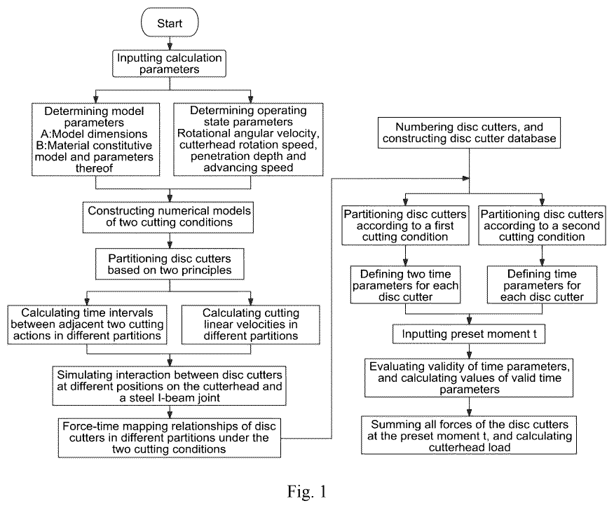

Provided herein is a method for calculating a cutterhead load during shield cutting of a diaphragm wall with a steel I-beam. As shown in FIG. 1, the method includes the following steps.

Step (1) Numerical model parameters and simulated working state parameters are determined, which specifically includes the following steps.

Step (11) A disc cutter-I-beam joint interaction process is simulated by using a finite element software LS-DYNA for dynamic analysis as a numerical analysis software.

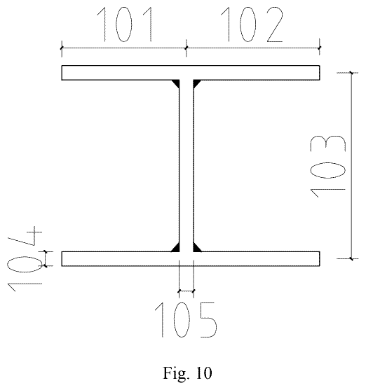

Step (12) The numerical model parameters are determined, including dimensions of a plurality of disc cutters, dimensions of the steel I-beam joint, dimensions of a concrete encasing the steel I-beam, material model and parameters of the plurality of disc cutters, material model and parameters of the steel I-beam joint, material model and parameters of the concrete, and connection node type between the concrete and the steel I-beam joint. FIG. 10 shows cross-sectional dimensions of the steel I-beam joint in this embodiment.

(13) The operating state parameters are determined, including rotational angular velocity co of the plurality of disc cutters, rotation speed co of a cutterhead, penetration depth n of the plurality of disc cutters and advancing speed V of the cutterhead. The advancing speed V is calculated through Equation (1):

$$V = ω \cdot n \qquad ( 1 )$$

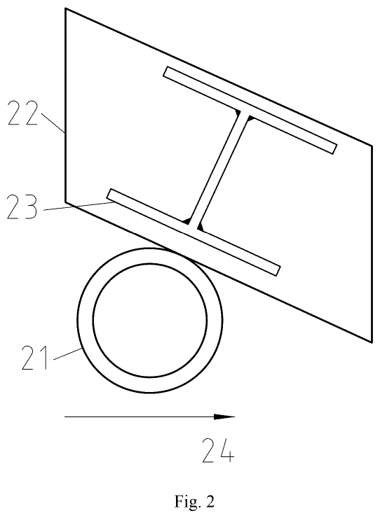

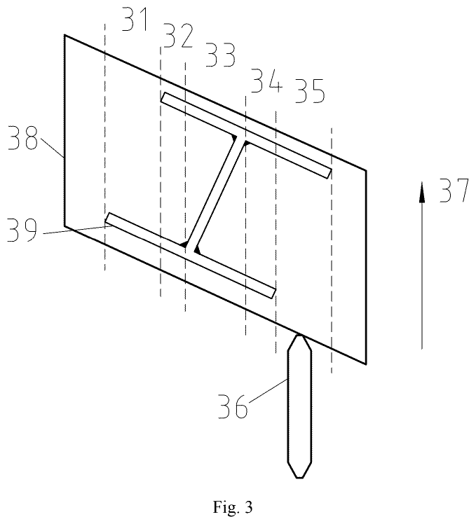

Step (2) Numerical simulation models for the interaction between the disc cutters and the steel I-beam joint are constructed. As shown in FIGS. 2 and 3, based on a positional relationship when the disc cutters cut the steel I-beam joint, a first numerical simulation model corresponding to a first cutting condition where a disc cutter axis is parallel to a depth direction of the diaphragm wall is constructed, and a second numerical simulation model corresponding to a second cutting condition where the disc cutter axis is perpendicular to the depth direction is constructed.

Step (3) Numerical simulation of the disc cutters that are arranged at different position positions on the cutterhead cutting the steel I-beam joint is performed. In order to simulate the process of the plurality of disc cutters cutting the steel I-beam joint. Before calculation, the disc cutters need to be partitioned along a radial direction according to the positional relationship between the disc cutters and the steel I-beam joint. A set of operating state parameters is obtained through calculation for each partition, which is used for subsequent calculations. The operating state parameters are calculated through the following steps.

### Step (31) Determination of Disc Cutter Cutting Linear Velocity

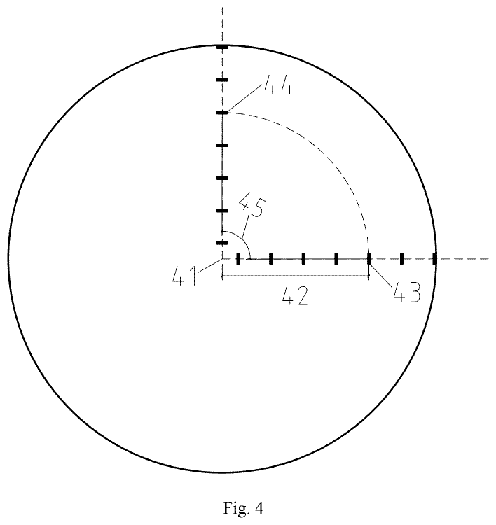

As shown in FIGS. 3 and 4, for the second numerical simulation model, a steel I-beam joint-concrete model is partitioned into 5 partitions along a direction perpendicular to a shield advancing direction, which are a first partition 31, a second partition 32, a third partition 33, a fourth partition 34 and a fifth partition 35. The 5 partitions correspond to specific disc cutters 43 at different positions along the radial direction on the simulated cutterhead, respectively. A distance from a midpoint of each of the 5 partitions to a rotation axis of the cutterhead is d(n=1, 2, . . . , 5), where n represents a partition number of the 5 partitions. The cutting linear velocity corresponding to each of the 5 partitions is calculated through Equation (2):

$${v}_{n} = ω \cdot {d}_{n} ( n = 1 , 2 , … , 5 ) \qquad ( 2 )$$

In the Equation (2), vₙ is the cutting linear velocity of disc cutters in an n-th partition among the 5 partitions, ω is the rotation speed of the cutterhead in r/min;

For the first numerical simulation model, the disc cutters are partitioned into N partitions along the radial direction, where N is a total number of conical cutterhead stages. The N partitions correspond to specific disc cutters 43 at different positions along the radial direction on the simulated cutterhead, respectively. A distance from a midpoint of each of the N partitions to the rotation axis of the cutterhead is dₘ(m=1, 2, . . . , N), where m is a partition number of the N partitions. The cutting linear velocity corresponding to each of the N partitions is calculated through Equation (3):

$${v}_{m} = ω \cdot {d}_{m} ( m = 1 , 2 , … , N ) \qquad ( 3 )$$

### Step (32) Determination of Time Interval Between Two Adjacent Cutting Actions of the Disc Cutters

As shown in FIG. 4, for both the first numerical simulation model and the second numerical simulation model, according to the differences in the disc cutter arrangement of different cutterheads, specific positions of the steel I-beam joint will be subjected to several cutting actions by the disc cutters during one rotation cycle of the cutterhead. In the numerical simulation, the time interval is calculated through Equation (4):

$$Δ {t}_{i} = \frac{{θ}_{i}}{ω} ( i = m , n ) \qquad ( 4 )$$

In the Equation (4), Δtᵢ is the time interval between two adjacent cutting actions of disc cutters in an i-th partition among the 5 partitions and the N partitions, and θᵢ is an adjacent angle 45 between a line connecting one of the adjacent two disc cutters at a distance dᵢ from a rotation center 41 of the cutterhead to the rotation center 41 and a line connecting the other of the adjacent two disc cutters at the distance d; from the rotation center 41 to the rotation center 41.

Step (33) The cutting linear velocity of the disc cutter in the i-th partition for cutting the steel-I beam joint-concrete is vᵢ(i=m,n), and the time interval between two adjacent cutting actions of the disc cutters is Δtᵢ(i=m,n). A total of N partitions of numerical simulation calculations need to be performed for the first numerical simulation model, and 5 partitions of numerical simulation calculations need to be performed for the second numerical simulation model. Thus, a total of 5+N numerical simulation calculations are performed for the first and second cutting conditions.

### Step (4) Output of Numerical Simulation Results

Based on the numerical simulation results of different cutting linear velocities in a total of 5+N partitions under the first and second cutting conditions, mapping relationships between vertical force and time Fₘ(t)(m=1, 2, . . . , N) and fₙ(t)(n=1, 2, . . . , 5), and mapping relationships between rolling force and time Tₘ(t)(m=1, 2, . . . , N) and tₙ(t)(n=1, 2, . . . , 5) are obtained.

Fₘ(t) represents a mapping relationship between time and a vertical force of a disc cutter in an m-th partition of the first numerical simulation model. fₙ(t) represents a mapping relationship between time and a vertical force of a disc cutter in an n-th partition of the second numerical simulation model. Tₘ(t) represents a mapping relationship between time and a rolling force of a disc cutter in the m-th partition of the first numerical simulation model. tₙ(t) represents a mapping relationship between time and a rolling force of a disc cutter in the n-th partition of the second numerical simulation model.

### Step (5) Numbering of Disc Cutters

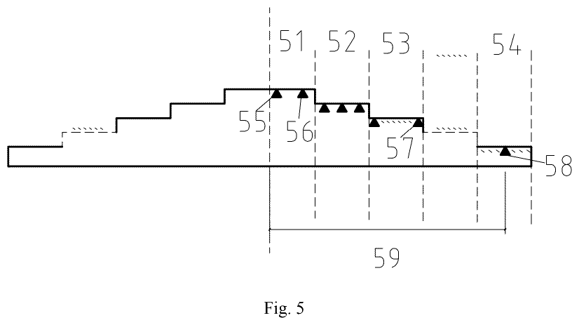

As shown in FIG. 5, the conical cutterhead is radially partitioned into N stages from its symmetric center, with a cutter height difference existing between adjacent two stages. Each of the N stages is provided with M disc cutters. A disc cutter number is composed of a two-element array (i, j), which refers to an j-th disc cutter on an i-th stage. x_{i,j} represents a distance from the j-th disc cutter on the i-th stage to the rotation center. A disc cutter database is constructed, and the number of each of the disc cutters and a distance from the rotation center 41 to each of the disc cutters are stored in the disc cutter database with the disc cutter numbers serving as disc cutter indexes.

### Step (6) Radial Partitioning of Disc Cutters

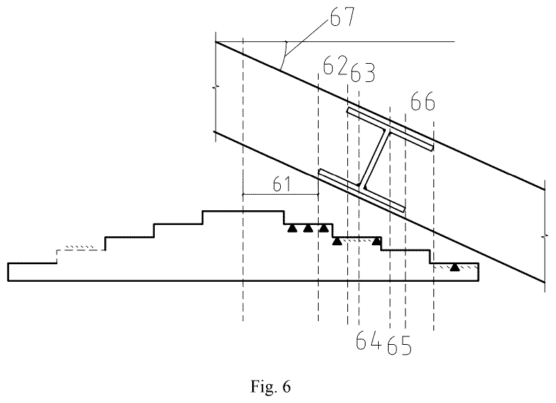

As shown in FIG. 6, for the second cutting condition, according to the relative position between the disc cutters and the steel I-beam joint, the disc cutters are partitioned into 5 partitions along the radial direction of the cutterhead, which are a sixth partition 62, a seventh partition 63, an eighth partition 64, a nineth partition 65 and a tenth partition 66. In this embodiment, the steel I-beam joint is located at a right front of the shield cutterhead. The specific partitioning principle is described as follows.

Within a range of L<x_{i,j}≤L+(c+d)·sin α, the corresponding disc cutters only participate in the cutting of a soil-facing flange plate of the steel I-beam joint, the mapping relationship between vertical force and time conforms to f₁(t), and the mapping relationship between rolling force and time conforms to t₁(t).

With in a range of

$$L + ( c + d ) \cdot sin α < {x}_{i , j} \leq L + d \cdot sin α + \frac{α}{cos α} ,$$

the corresponding disc cutters participate in the cutting of the soil-facing flange plate and a soil-backing flange plate of the steel I-beam joint, the mapping relationship between vertical force and time conforms to f₂(t), and the mapping relationship between rolling force and time conforms to t₂(t).

With in a range of

$$L + d \cdot sin α + \frac{a}{cos α} < {x}_{i , j} \leq L + d \cdot sin α + \frac{a}{cos α} + c \cdot sin α ,$$

the corresponding disc cutters participate in the cutting of the soil-facing flange plate, the soil-backing flange plate and a web plate of the steel I-beam joint, the mapping relationship between vertical force and time conforms to f₃(t), and the mapping relationship between rolling force and time conforms to t₃(t).

With in a range of

$$L + d \cdot sin α + \frac{a}{cos α} + c \cdot sin α < {x}_{i , j} \leq L + ( a + b ) \cdot cos α + d \cdot sin α ,$$

the corresponding disc cutters participate in the cutting of the soil-facing flange plate and the soil-backing flange plate, the mapping relationship between vertical force and time conforms to f₄(t), and the mapping relationship between rolling force and time conforms to t₄(t).

With in a range of L+(a+b)·cos α+d·sin α<x_{i,j}≤L+(a+b)·cos α+d·sin α+(c+d)·sin α, the corresponding disc cutters only participate in the cutting of the soil-backing flange plate, the mapping relationship between vertical force and time conforms to f₅(t), and the mapping relationship between rolling force and time conforms to t₅(t).

In the above ranges, L is a minimum distance 61 from the soil-facing flange plate to the rotation center, x_{i,j} is a distance from the j-th disc cutter on the i-th stage to the rotation center, α is an angle 67 between the cutterhead and the steel I-beam joint when the cutterhead is not in contact with the steel I-beam joint, a is a length of a flange plate located on a left side of the web plate, b is a length of a flange plate located on a right side of the web plate, c is a height of the web plate, and both a thickness 104 of the flange plate and a thickness 105 of the web plate are d.

For the first cutting condition, the disc cutters are partitioned into N partitions along the radial direction, where N is the number of the conical cutterhead stages. For any partition m, the mapping relationship between vertical force and time conforms to Fₘ(t)(m=1, 2, . . . , N), and the mapping relationship between rolling force and time conforms to Tₘ(t)(m=1, 2, . . . , N).

After all disc cutters are partitioned based on the above partitioning principle, partition information and the corresponding force-time mapping relationships are stored in the disc cutter database in one-to-one correspondence with the disc cutter indexes.

### Step (7) Calculation of Time Parameters of Disc Cutters

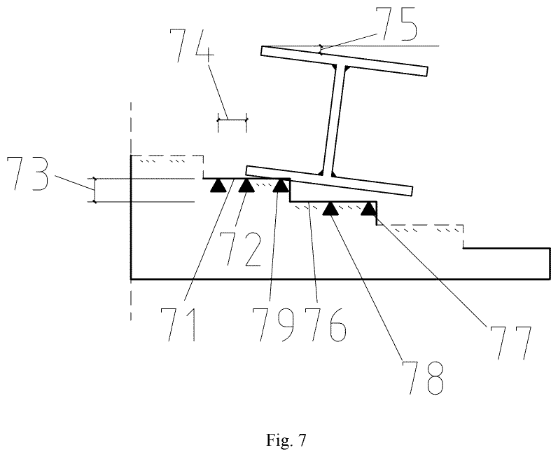

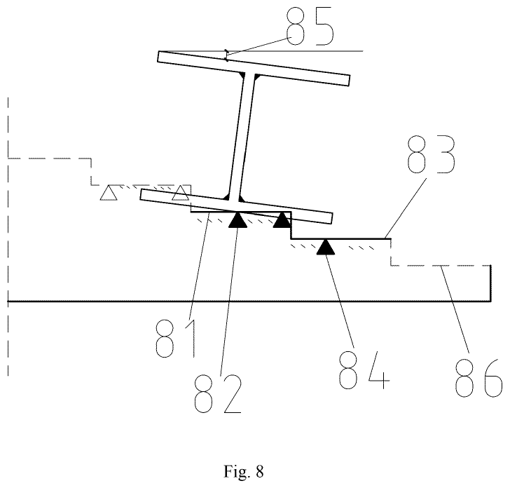

As shown in FIGS. 7 and 8, due to the conical design of the cutterhead, there exist an angle 75 between the cutterhead and the steel I-beam joint when an I-th stage of the cutterhead starts to contact the steel I-beam joint, and an angle 85 between the cutterhead and the steel I-beam joint when a J-th disc cutter of an (I₁−1)-th stage starts to contact the steel I-beam joint. There are differences in the contact time with the steel I-beam joint between different cutterhead stages and between different disc cutters on the same cutterhead stage. The present disclosure introduces time parameters T_{i,j(1)} and T_{i,j(2)} to describe the time differences when disc cutters at different positions begin to contact the steel I-beam; T_{i,j(11)} and T_{i,j(12)} represent two time parameters of the j-th disc cutter on the i-th stage under the first cutting condition, and T_{i,j(2)} represents the time parameter of the j-th disc cutter on the i-th stage under the second cutting condition. The calculation steps are as follows.

For the second cutting condition, the calculation is performed the following steps.

Step (71) As shown in FIG. 7, iₘᵢₙ=I is a minimum value of i satisfying x_{i,j}>L, and jₘᵢₙ=J is a minimum value of j on the I-th stage satisfying x_{i,j}>L. A moment when an M-th disc cutter on the I-th stage starts contacting the steel I-beam joint is denoted as t=0, and the M-th disc cutter is the one farthest from the rotation center on the I-th stage. The time parameter of the M-th disc cutter is defines as Equation (5):

$${T}_{I , M ( 2 )} = t \qquad ( 5 )$$

In the Equation (5), t is a time elapsed after the moment the M-th disc cutter on the I-th stage starts contacting the steel I-beam joint, the same applies below.

Step (72) As the cutterhead advances along the tunneling direction, an (M−1)-th disc cutter on the I-th stage starts to contact the steel I-beam joint with a contact moment delayed by Δt compared to the M-th disc cutter 79 on the I-th stage. The time parameter of the (M−1)-th disc cutter is defined as Equation (6):

$${T}_{I , ( M - 1 ) ( 2 )} = t - {t}_{Δ} \qquad ( 6 )$$

By analogy, the time parameter of a J-th disc cutter on the I-th stage is defined as Equation (7):

$${T}_{I , J ( 2 )} = t - ( M - J ) {t}_{Δ} \qquad ( 7 )$$

t_{Δ} is the time difference between moments when adjacent two disc cutters on the I-th stage start to contact the steel I-beam joint, and is calculated through Equation (8):

$${t}_{Δ} = \frac{Δ \cdot tan α}{V} \qquad ( 8 )$$

In the Equation (8), Δ is a disc cutter spacing on the I-th stage; α is the angle between the cutterhead and the steel I-beam joint, i.e., an angle between the cutterhead and the diaphragm wall; V is the cutterhead advancing speed; M is a total number of disc cutters on the I-th stage.

Step (73) As the cutterhead continuously advances, the contact time of the M-th disc cutter 77 on an (I+1)-th stage with the steel I-beam joint is delayed by

$$\frac{{h}_{I}}{V}$$

compared to the M-th disc cutter 79 on the I-th stage, where

$$\frac{{h}_{I}}{V}$$

is a height difference 73 between the I-th stage and the (I+1)-th stage, and V is the advancing speed of the cutterhead. The time parameter of the M-th disc cutter 77 on the (I+1)-th stage is defined as Equation (9):

$${T}_{( I + 1 ) , {M}_{I + 1} ( 2 )} = t - \frac{{h}_{I}}{V} \qquad ( 9 )$$

In the Equation (9), the M_{I+1}+-th disc cutter is an outermost disc cutter on the (I+1)-th stage.

Following the step (72), the time parameter of a J-th disc cutter 78 on the (I+1)-th stage is define as Equation (10):

$${T}_{( I + 1 ) , J ( 2 )} = t - \frac{{h}_{I}}{V} - ( {M}_{I + 1} - J ) {t}_{Δ} \qquad ( 10 )$$

In the Equation (10), M_{I+1} is a total number of disc cutters on the (I+1)-th stage.

Step (74) As shown in FIG. 8, more generally, the time parameter of the J-th disc cutter 82 on the (I₁−1)-th stage is define as Equation (11):

$${T}_{{I}_{1} - 1 , J ( 2 )} = t - \frac{{\sum }_{i = I}^{( {I}_{1} - 2 )} {h}_{i}}{V} - ( {M}_{{I}_{1} - 1} - J ) {t}_{Δ} ( I \leq ( {I}_{1} - 1 ) < {I}_{1} ) \qquad ( 11 )$$

In the Equation (11), M_{I}_{₁}₋₁ is a total number of disc cutters on the (I₁−1)-th stage.

Step (75) iₘₐₓ=I₁ is a maximum value of i satisfying x_{i,j}≤L+(a+b)·cos α+d·sin α+(c+d)·sin α. All disc cutters on the (I₁+1)-th stage to the N-th stage has time parameters of T_{i,j(2)}=0.

After definition of time parameters of all disc cutters on the cutterhead under the second cutting condition is completed based on the above method, all time parameters of the plurality of disc cutters are stored in the disc cutter database in one-to-one correspondence with the disc cutter indexes.

For the first cutting condition, the calculation is performed the following steps.

Different from the second cutting condition, all disc cutters on the same stage contact the steel the I-beam joint in the form of the first cutting condition at the same moment. For each full rotation of the cutterhead, disc cutters at any position satisfying x_{i,j}>m will cut the steel I-beam joint twice in the form of the first cutting condition, hence there are two time parameters Tᵢ₍₁₁₎ and Tᵢ₍₁₂₎, which are calculated through the following steps.

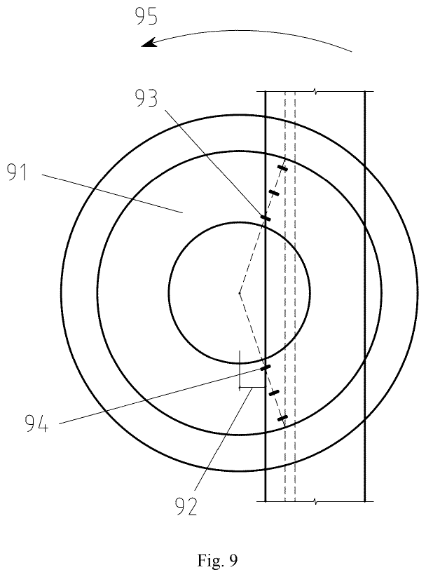

Step (76) As shown in FIG. 9, without loss of generality, it is assumed that the shield cutterhead rotates counterclockwise. Following the step (72), the time when the (I₁−1)-th stage 91 starts contacting the steel I-beam joint in the form of second cutting condition is calculated through Equation (12):

$${T}_{( {I}_{1} - 1 ) ( 2 )} = t - \frac{{\sum }_{i = 1}^{{I}_{1} - 2} {h}_{i}}{V} \qquad ( 12 )$$

After another t₁, the J-th disc cutter on the (I₁−1)-th stage cuts the steel I-beam joint for the first time under the first cutting condition 93, t₁ is calculated through Equation (13):

$${t}_{1} = \frac{{cos}^{- 1} \frac{L}{{X}_{( {I}_{1} - 1 ) , J}}}{ω} \qquad ( 13 )$$

A first time parameter of the J-th disc cutter on the (I₁−1)-th stage is calculated through Equation (14):

$${T}_{( {I}_{1} - 1 ) , J ( 11 )} = {T}_{( {I}_{1} - 1 ) ( 2 )} - {t}_{1} = t - \frac{{\sum }_{i = I}^{( {I}_{1} - 2 )} {h}_{i}}{V} - \frac{{cos}^{- 1} \frac{L}{{x}_{( {I}_{1} - 1 ) , J}}}{ω} \qquad ( 14 )$$

After another t₂, the J-th disc cutter on the (I₁−1)-th stage cuts the steel I-beam joint for the second time under the first cutting condition 94, t₂ is calculated through Equation (15):

$${t}_{2} = \frac{2 ( π - {cos}^{- 1} \frac{L}{{x}_{( {I}_{1} - 1 ) , J}} )}{ω} \qquad ( 15 )$$

A second time parameter of the J-th disc cutter on the (I₁−1)-th stage is calculated through equation (16):

$${T}_{( {I}_{1} - 1 ) , J ( 12 )} = {T}_{( {I}_{1} - 1 ) ( 2 )} - {t}_{1} - {t}_{2} - t - \frac{{\sum }_{i = I}^{( {I}_{1} - 2 )} {h}_{i}}{V} - \frac{2 π - {cos}^{- 1} \frac{L}{{x}_{( {I}_{1} - 1 ) , J}}}{ω} \qquad ( 16 )$$

Step (78) The difference from the second cutting condition is that for any disc cutter on a stage i>I₁, T_{i,j(11)} and T are not zero, and the calculation method is the same as the steps (76) and (77).

After definition of time parameters of all disc cutters on the cutterhead under the first cutting condition is completed based on the above method, all time parameters of the plurality of disc cutters are stored in the disc cutter database in one-to-one correspondence with the disc cutter indexes.

Step (8) A specific moment t is inputted and a validity of the time parameters for all disc cutters at the moment t is evaluated. The present disclosure holds that the time parameters defined in the step (7) serve as the criterion for the disc cutters to start working, that is, when T_{i,j}>0, the time parameter is in a valid state, and the disc cutters start cutting.

After performing the steps (5)-(7), the disc cutter database contains the following information for each disc cutter: [disc cutter number (i, j), distance from disc cutter to rotation center x_{i,j}, disc cutter partition m of the first cutting condition, first time parameter T_{i,j(11)} of the first cutting condition, second time parameter T_{i,j(12)} of the first cutting condition, disc cutter partition n of the second cutting condition, and time parameter T_{i,j(2)} of the second cutting condition].

A time parameter solving program is written to traverse all disc cutter information in the disc cutter database and the three time parameters of all the disc cutters at an input moment are calculated.

Step (9) The cutterhead load includes a frontal resistance F and a resistance moment T. A frontal resistance and resistance moment of the cutterhead at the specific moment t are calculated. Based on the time parameters calculated in the step (8) and the force-time mapping relationship corresponding to the disc cutter partitions, the vertical force and rolling force of each disc cutter at the moment t are calculated. The frontal resistance of the cutterhead is a normal cutting resistance when disc cutters pass through obstacles, so the vertical forces of all working disc cutters at the moment t are summed to calculate the frontal resistance of the cutterhead. The resistance moment of the cutterhead is a moment generated when disc cutters cut obstacles, so the rolling moments of all working disc cutters at the moment t are summed to calculate the resistance moment of the cutterhead. The specific steps are as follows.

Step (91) Without loss of generality, it is assumed that at the moment t, the time parameters T_{i,j(2)}, T_{i,j(11)} and T_{i,j(11)} of a disc cutter with number (i, j) are all greater than 0. The disc cutter partition of first cutting condition is m, the disc cutter partition of the second cutting condition is n, the vertical force F_{i,j} and torque T_{i,j} of the disc cutter are calculated through Equations (17) and (18), respectively:

$${F}_{i , j} = {F}_{m} ( {T}_{i , j ( 11 )} ) + {F}_{m} ( {T}_{i , j ( 12 )} ) + {f}_{n} ( {T}_{i , j ( 2 )} ) \qquad ( 17 )$$

$${T}_{i , j} = [ {T}_{m} ( {T}_{i , j ( 11 )} ) + {T}_{m} ( {T}_{i , j ( 12 )} ) + {t}_{n} ( {T}_{i , j ( 2 )} ) ] \cdot {x}_{i , j} \qquad ( 18 )$$

In contrast, each disc cutter with T_{i,j} less than 0 among the disc cutters with the valid time parameters satisfies Fₘ(T_{i,j})=fₙ(T_{i,j})=Tₘ(T_{i,j})=tₙ(T_{i,j})=0.

Step (92) The vertical forces F and torques 77 of all disc cutters with time parameters satisfying T_{i,j}>0 are summed to calculate the front resistance F and resistance torque T of the cutterhead at the moment t through Equations (19) and (20), respectively:

$$F = {\sum }_{{T}_{i , j} > 0} {F}_{i , j} \qquad ( 19 )$$

$$T = {\sum }_{{T}_{i , j} > 0} {T}_{i , j} \qquad ( 20 )$$

The embodiments described above are merely illustrative of the present application, and are not intended to limit the scope of the present application. Any modifications or equivalent substitutions made based on principles of the present application shall fall within the scope of the disclosure defined by the appended claims.

What is claimed is:

1. A method for calculating a cutterhead load during shield cutting of a diaphragm wall with a steel I-beam, comprising:
(1) determining numerical model parameters and operating state parameters of a first numerical simulation model and a second numerical simulation model for disc cutter-steel I-beam joint interaction;
(2) constructing the first numerical simulation model corresponding to a first cutting condition and the second numerical simulation model corresponding to a second cutting condition based on a positional relationship during disc cutter cutting of a steel I-beam joint;
(3) changing a disc cutter cutting linear velocity and a time interval between two adjacent disc cutter cutting actions, and simulating an interaction process between a plurality of disc cutters varying in position on a cutterhead and the steel I-beam joint;
(4) outputting mapping relationships between time and vertical forces exerted on the plurality of disc cutters during the interaction process, and outputting mapping relationships between time and rolling forces exerted on the plurality of disc cutters during the interaction process;
(5) numbering each of the plurality of disc cutters, and constructing a disc cutter database;
(6) partitioning the plurality of disc cutters based on different partitioning principles of the first cutting condition and the second cutting condition;
(7) defining time parameters of each of the plurality of disc cutters;
(8) evaluating a validity of the time parameters at a preset moment, and calculating values of valid time parameters among the time parameters; and
(9) summing vertical forces of disc cutters with the valid time parameters, summing rolling torques of the disc cutters with the valid time parameters, and calculating the cutterhead load at the preset moment.

2. The method of claim 1, wherein step (1) comprises:
(11) simulating the interaction process by using an LS-DYNA finite element software for dynamic analysis as a numerical analysis software;
(12) determining the numerical model parameters, wherein the numerical model parameters comprise dimensions of the plurality of disc cutters, dimensions of the steel I-beam joint, dimensions of a concrete encasing the steel I-beam, material model and parameters of the plurality of disc cutters, material model and parameters of the steel I-beam, material model and parameters of the concrete, and connection node type between the concrete and the steel I-beam joint; and
(13) determining the operating state parameters, wherein the operating state parameters comprise rotational angular velocity ω₀ of the plurality of disc cutters, rotation speed ω of the cutterhead, penetration depth n of the plurality of disc cutters and advancing speed V of the cutterhead; and the advancing speed V is calculated through equation (1):
$$V = ω \cdot n . \qquad ( 1 )$$

3. The method of claim 2, in step (2), the first cutting condition is a condition where a disc cutter axis is parallel to a depth direction of the diaphragm wall; the second cutting condition is a condition where the disc cutter axis is perpendicular to the depth direction.

4. The step of claim 3, wherein step (3) comprises:
(31) partitioning the steel I-beam joint and a concrete part in the second numerical simulation model into 5 first partitions along a direction perpendicular to a shield advancing direction to simulate the disc cutter cutting linear velocity of disc cutters in the second numerical simulation model among the plurality of disc cutters; wherein a distance from a midpoint of each of the 5 first partitions to a rotation axis of the cutterhead is dₙ(n=1, 2, . . . , 5), and n represents a partition number of the 5 first partitions; and
calculating the disc cutter cutting linear velocity corresponding to each of the 5 first partitions through equation (2):
$${v}_{n} = ω \cdot {d}_{n} ( n = 1 , 2 , … , 5 ) , \qquad ( 2 )$$
wherein vₙ is the disc cutter cutting linear velocity in an n-th partition among the 5 partitions, and a unit of the rotation speed ω is r/min;
partitioning disc cutters in the first numerical simulation model among the plurality of disc cutters into N second partitions along a radial direction of the cutterhead to simulate the disc cutter cutting linear velocity in the first numerical simulation model; wherein the cutterhead is a conical cutterhead, N is a total number of stages of the conical cutterhead, a distance from a midpoint of each of the N second partitions to the rotation axis is dₘ(m=1, 2, . . . , N), and m is a partition number of the N second partitions; and
calculating the disc cutter cutting linear velocity corresponding to each of the N second partitions through equation (3):
$${v}_{m} = ω \cdot {d}_{m} ( m = 1 , 2 , … , N ) ; \qquad ( 3 )$$
(32) for the first numerical simulation model and the second numerical simulation model, due to a fact that depending on a disc cutter layout of different cutterheads, a specific location of the steel I-beam joint is subjected to a plurality of cutting actions by the plurality of disc cutters during one rotation cycle of the cutterhead, calculating the time interval through equation (4):
$$Δ {t}_{i} = \frac{{θ}_{i}}{ω} ( i = m , n ) , \qquad ( 4 )$$
wherein Δtᵢ is the time interval in an i-th partition among the 5 first partitions and the N second partitions, and θᵢ is an angle between a line connecting one of the adjacent two disc cutters at a distance dᵢ(i=m,n) from a rotation center of the cutterhead to the rotation center and a line connecting the other of the adjacent two disc cutters at the distance d; from the rotation center to the rotation center;
(33) performing numerical simulation calculation on the 5 first partitions and the N second partitions to obtain numerical simulation results, wherein a cutting linear velocity of a disc cutter in the i-th partition cutting the steel I-beam joint and the concrete is vᵢ(i=m,n), the time interval of the disc cutter in the i-th partition is Δt(i=m,n), and the numerical simulation calculation is performed a total of 5+N times.

5. The method of claim 4, wherein step (4) comprises:
based on the numerical simulation results, obtaining a mapping relationship between time and a vertical force of a disc cutter in an m-th partition Fₘ(t)(m=1, 2, . . . , N), a mapping relationship between time and a vertical force of a disc cutter in the n-th partition fₙ(t)(n=1, 2, . . . , 5), a mapping relationship between time and a rolling force of the disc cutter in the m-th partition Tₘ(t)(m=1, 2, . . . , N), and a mapping relationship between time and a rolling force of the disc cutter in the n-th partition tₙ(t)(n=1, 2, . . . , 5).

6. The method of claim 1, wherein in step (5), a numbering principle for the plurality of disc cutters comprises:
a disc cutter number consists of a two-element array (i, j) referring to an j-th disc cutter on an i-th stage of the cutterhead, and x_{i,j} represents a distance from the j-th disc cutter on the i-th stage to a rotation center of the cutterhead; the disc cutter number (i, j) and the distance x_{i,j} of each of the plurality of disc cutters are stored into the disc cutter database with the disc cutter number serving as indexes of the plurality of disc cutters.

7. The method of claim 6, wherein the cutterhead is a conical cutterhead; and
step (6) comprises:
(61) for the second numerical simulation model, partitioning the plurality of disc cutters into 5 first partitions along a radial direction of the cutterhead;
wherein disc cutters within a range of L<x_{i,j}≤L+(c+d)·sin α among the plurality of disc cutters only participate in cutting a soil-facing flange plate of the steel I-beam joint;
disc cutters within a range of
$$L + ( c + d ) \cdot sin α < {x}_{i , j} \leq L + d \cdot sin α + \frac{α}{cos α}$$
among the plurality of disc cutters participate in cutting the soil-facing flange plate and a soil-backing flange plate of the steel I-beam joint;
disc cutters within a range of
$$L + d \cdot sin α + \frac{a}{cos α} < {x}_{i , j} \leq L + d \cdot sin α + \frac{a}{cos α} + c \cdot sin α$$
among the plurality of disc cutters participate in cutting the soil-facing flange plate, the soil-backing flange plate, and a web plate of the steel I-beam joint;
disc cutters within a range of
$$L + d \cdot sin α + \frac{a}{cos α} + c \cdot sin α < {x}_{i , j} \leq L + ( a + b ) \cdot cos α + d \cdot sin α$$
among the plurality of disc cutters participate in cutting the soil-facing flange plate and the soil-backing flange plate;
disc cutters within a range of L+(a+b)·cos α+d·sin α<x_{i,j}≤L+(a+b)·cos α+d·sin α+(c+d)·sin α among the plurality of disc cutters only participate in cutting the soil-backing flange plate;
wherein L is a minimum distance from the soil-facing flange plate to the rotation center, α is an angle between the cutterhead and the steel I-beam joint; a is a length of a portion of the flange plate located on a first side of the web plate; b is a length of a portion of the right flange plate located on a second side of the web plate; c is a height of the web plate; d is a thickness of the flange plate and the web plate;
(62) for the first numerical simulation model, partitioning the plurality of disc cutters into N second partitions along the radial direction with stages of the conical cutterhead as boundaries, wherein N is a number of the stages; and
(63) after the partitioning is completed, storing partition information and the mapping relationships between time and the vertical forces and the mapping relationships between time and the rolling forces in the disc cutter database in one-to-one correspondence with the indexes.

8. The method of claim 7, wherein in step (7), the time parameters comprise T_{i,j(1)} and T_{i,j(2)} that are configured to describe a time difference when the plurality of disc cutters start contacting the steel I-beam; T_{i,j(1)} comprises T_{i,j(11)} and T_{i,j(12)} representing a first time parameter and a second time parameter of the j-th disc cutter on the i-th stage in the first cutting condition, respectively; T_{i,j(2)} represents a third time parameter of the j-th disc cutter on the i-th stage in second cutting condition; and the first time parameter T_{i,j(11)}, the second time parameter T_{i,j(12)} and the third time parameter T_{i,j(2)} are solved through steps of:
for the second cutting condition, it is set that iₘᵢₙ=I is a minimum value of i satisfying x_{i,j}>L, jₘᵢₙ=J is a minimum value of j on an I-th stage satisfying x_{i,j}>L, a moment when an outermost disc cutter on the I-th stage starts contacting the steel I-beam joint is t=0, and the outermost disc cutter is defined as an M-th disc cutter on the I-th stage, and the third time parameter T_{i,j(2)} is solved through steps of:
(71) calculating the third time parameter of the M-th disc cutter on the I-th stage through equation (5):
$${T}_{I , M ( 2 )} = t , \qquad ( 5 )$$
wherein t is a time elapsed since a moment when the M-th disc cutter on the I-th stage starts contacting the steel I-beam joint;
(72) calculating the third time parameter of an (M −1)-th disc cutter on the I-th stage through equation (6):
$${T}_{I , ( M - 1 ) ( 2 )} = t - {t}_{Δ} ; \qquad ( 6 )$$
calculating the third time parameter of a J-th disc cutter on the I-th stage through equation (7):
$${T}_{I , J ( 2 )} = t - ( M - J ) {t}_{Δ} , \qquad ( 7 )$$
wherein t_{Δ} is a time difference between moments when adjacent two disc cutters on the I-th stage start contacting the steel I-beam joint, and is calculated through equation (8):
$${t}_{Δ} = \frac{Δ \cdot tan α}{V} , \qquad ( 8 )$$
wherein Δ is a disc cutter spacing on the I-th stage; V is an advancing speed of the cutterhead; M is a total number of disc cutters on the I-th stage;
(73) calculating the third time parameter of an M_{I+1}-th disc cutter on an (I+1)-th stage through equation (9):
$${T}_{( I + 1 ) , {M}_{I + 1} ( 2 )} = t - \frac{{h}_{I}}{V} , \qquad ( 9 )$$
wherein the M_{I+1}-th disc cutter is an outermost disc cutter on the (I+1)-th stage, h_{I} is a height difference between the I-th stage and the (I+1)-th stage;
calculating the third time parameter of a J-th disc cutter on the (I+1)-th stage through equation (10):
$${T}_{( I + 1 ) , J ( 2 )} = t - \frac{{h}_{I}}{V} - ( {M}_{I + 1} - J ) {t}_{Δ} , \qquad ( 10 )$$
wherein M_{I+1} is a total number of disc cutters on the (I+1)-th stage;
(74) calculating the third time parameter of a J-th disc cutter on an (I₁−1)-th stage through equation (11):
$${T}_{{I}_{1} - 1 , J ( 2 )} = t - \frac{{\sum }_{i = 1}^{( {I}_{1} - 2 )} {h}_{i}}{V} - ( {M}_{{I}_{1} - 1} - J ) {t}_{Δ} ( I \leq ( {I}_{1} - 1 ) < {I}_{1} ) ; \qquad ( 11 )$$
wherein M_{I}_{₁}₋₁ is a total number of disc cutters on the (I₁−1)-th stage, iₘₐₓ=I₁ is a maximum value of i satisfying x_{i,j}≤L+(a+b)·cos α+d·sin α+(c+d)·sin α, and the third time parameter of each disc cutter on an (I₁+1)-th to an N-th stage satisfies T_{i,j(2)}=0;
(75) storing third time parameters of the plurality of disc cutters in the disc cutter database in one-to-one correspondence with the indexes;
for the first cutting condition, the first time parameter T_{i,j(11)} and the second time parameter T_{i,j(12)} are solved through steps of:
(76) calculating a time when the (I₁−1)-th stage starts contacting the steel I-beam joint through equation (12):
$${T}_{( {I}_{1} - 1 ) ( 2 )} = t - \frac{{\sum }_{i = 1}^{{I}_{1} - 2} {h}_{i}}{V} ; \qquad ( 12 )$$
calculating a time t₁ elapsed from a moment when the the (I₁−1)-th stage starts contacting the steel I-beam joint until the J-th disc cutter on the (I₁−1)-th stage cuts the steel I-beam joint for a first time through equation (13):
$${t}_{1} = \frac{{cos}^{- 1} \frac{L}{{X}_{( {I}_{1} - 1 ) , J}}}{ω} ; \qquad ( 13 )$$
calculating the first time parameter of the J-th disc cutter on the (I₁−1)-th stage through equation (14):
$${T}_{( {I}_{1} - 1 ) , J ( 11 )} = {T}_{( {I}_{1} - 1 ) ( 2 )} - {t}_{1} = t - \frac{{\sum }_{i = I}^{( {I}_{1} - 2 )} {h}_{i}}{V} - \frac{{cos}^{- 1} \frac{L}{{x}_{( {I}_{1} - 1 ) , J}}}{ω} ; \qquad ( 14 )$$
(77) calculating a time t₂ elapsed from a moment when the J-th disc cutter on the (I₁−1)-th stage cuts the steel I-beam joint for the first time until a moment when the J-th disc cutter on the (I₁−1)-th stage cuts the steel I-beam joint for a second time through equation (15):
$${t}_{2} = \frac{2 ( π - {cos}^{- 1} \frac{L}{{x}_{( {I}_{1} - 1 ) , J}} )}{ω} ; \qquad ( 15 )$$
calculating the second time parameter of the J-th disc cutter on the (I₁−1)-th stage through equation (16):
$${T}_{( {I}_{1} - 1 ) , J ( 12 )} = {T}_{( {I}_{1} - 1 ) ( 2 )} - {t}_{1} - {t}_{2} - t - \frac{{\sum }_{i = I}^{( {I}_{1} - 2 )} {h}_{i}}{V} - \frac{2 π - {cos}^{- 1} \frac{L}{{x}_{( {I}_{1} - 1 ) , J}}}{ω} ; \qquad ( 16 )$$
(78) calculating T_{i,j(11)} and T_{i,j(12)} of any disc cutter on a stage satisfying i>I₁ with the same calculation method as steps (76) and (77), wherein values of T_{i,j(11)} and of any disc cutter on the stage satisfying i>I₁ are non-zero; and
storing the time parameters of the plurality of disc cutters in the disc cutter database in one-to-one correspondence with the indexes.

9. The method of claim 8, wherein in step (8), time parameters satisfying T_{i,j}>0 are determined as the valid time parameters, and the disc cutters with the valid time parameters are determined to be in an operating state.

10. The method of claim 9, wherein the cutterhead load comprises a frontal resistance F and a resistance moment T; and
step (9) is performed through steps of:
(91) calculating a vertical force F_{i,j} and a rolling torque T_{i,j} of each disc cutter with T_{i,j(2)}, T_{i,j(11)} and all greater than 0 among the disc cutters with the valid time parameters through equations (17) and (18), respectively:
$${F}_{i , j} = {F}_{m} ( {T}_{i , j ( 11 )} ) + {F}_{m} ( {T}_{i , j ( 12 )} ) + {f}_{n} ( {T}_{i , j ( 2 )} ) ; \qquad ( 17 )$$
$${T}_{i , j} = [ {T}_{m} ( {T}_{i , j ( 11 )} ) + {T}_{m} ( {T}_{i , j ( 12 )} ) + {t}_{n} ( {T}_{i , j ( 2 )} ) ] \cdot {x}_{i , j} ; \qquad ( 18 )$$
in contrast, each disc cutter with T_{i,j} less than 0 among the disc cutters with the valid time parameters satisfies Fₘ(T_{i,j})=fₙ(T_{i,j})=Tₘ(T_{i,j})=tₙ (T_{i,j})=0;
(92) summing vertical forces F_{i,j} of disc cutters with T_{i,j} greater than 0 to obtain the frontal resistance F acting on the cutterhead at the preset moment t through equation (19):
$$F = {\sum }_{{T}_{i , j} > 0} {F}_{i , j} ; \qquad ( 19 )$$
summing rolling torques T_{i,j} of the disc cutters with T_{i,j} greater than 0 to obtain the resistance moment T acting on the cutterhead at the preset moment t through equation (20):
$$T = {\sum }_{{T}_{i , j} > 0} {T}_{i , j} . \qquad ( 20 )$$

11. A non-transitory computer-readable storage medium, wherein a computer instruction is stored on the non-transitory computer-readable storage medium; and the computer instruction is configured to be executed by a processor to implement the method of claim 1.

12. An electronic device, comprising:
a processor;
a memory; and
a computer program stored on the memory;
wherein the computer program is configured to be executed by the processor to implement the method of claim 1.
